(19) United States
(12) Patent Application Publication
(10) Pub. No.: US 2008/0117048 A1
(43) Pub. Date: May 22, 2008

(54) Method and System for Facilitating Communication Between a Radio Frequency Identification (RFID) Device and RFID Tags

(75) Inventors: Richard S. Rachwalski, Lemont, IL (US); Timothy J. Collins, Homer Glen, IL (US); Michael K. Bullock, Prairie Grove, IL (US); Andreas Schaller, Wiesbaden (DE)

Correspondence Address: PRASS & IRVING LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/560,945

(22) Filed: Nov. 17, 2006

(51) Int. Cl. G08B 13/14

(52) U.S. Cl. 340/572.1

(57) ABSTRACT

A method and system for facilitating radio frequency (RF) communication between a radio frequency identification (RFID) device and RFID tags is disclosed. The method may include associating one or more RFID tags to one or more containers that comprise a container volume, wherein the RF signal communication between the RFID device and one or more of the RFID tags is at least partially obstructed, and integrating at least one conductive surface into the container volume, wherein if the RFID device is coupled to at least one of the conductive surfaces and energized, the RFID device, the at least one conductive surface and one or more of the RFID tags are capacitively coupled allowing RF signals to be communicated between RFID device and the one or more RFID tags in the container volume without being obstructed.

### BACKGROUND OF THE INVENTION

1. Field of the Invention

The present invention relates radio frequency identification, and more particularly, to a method and system for facilitating communication between a radio frequency identification (RFID) device and RFID tags.

2. Introduction

Item level tagging is a process of placing Radio Frequency Identification (RFID) tags on individual product items. Currently, there are some RIFD applications where an RIFD tag is placed on the actual shipping pallet containing multiple items to identify the pallet and then using a database to associate the pallet ID number, the pallet with what was believed to have been placed on the pallet. This process requires manual entry at some stages and mistakes can be and are made. Thus, this process does not account for accuracy and the potential for tampering.

Therefore, industry is looking at RIFD up and down the supply chain as a way to improve inventory accuracy and tracking down to the item level. However, one of the problems with RIFD is that since it is a wireless communication technology (radio frequency (RF) technology) it subject to electromagnetic phenomenon common to all radio signals that can interfere with signal transmission and reception.

This problem is particularly apparent if the signal must penetrate an obstructed volume that includes containers with arbitrary materials, different sizes, orientation, etc. As a result, the signal becomes very unpredictable for that volume. For example, in a pallet-type situation, signals from containers having RFID tags located in the interior of the volume will be difficult to receive because of the electromagnetic effects and density of the packaging volume. Thus, with the current systems it is difficult to guarantee that the signal will penetrate to every tag in the volume stack to allow RFID tags to be read in order to get an accurate inventory.

### SUMMARY OF THE INVENTION

A method and system for facilitating radio frequency (RF) communication between a radio frequency identification (RFID) device and RFID tags is disclosed. The method may include associating one or more RFID tags to one or more containers that comprise a container volume, wherein the RF signal communication between the RFID device and one or more of the RFID tags is at least partially obstructed, and integrating at least one conductive surface into the container volume, wherein if the RFID device is coupled to at least one of the conductive surfaces and energized, the RFID device, the at least one conductive surface and one or more of the RFID tags are capacitively coupled allowing RF signals to be communicated between the RFID device and the one or more RFID tags in the container volume without being obstructed.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary diagram of an dipole RFID tag reading system in accordance with a possible embodiment of the invention;

FIG. 2 illustrates an exemplary diagram of an monopole RFID tag reading system in accordance with a possible embodiment of the invention;

FIG. 3 illustrates an exemplary block diagram of an RFID tag in accordance with a possible embodiment of the invention;

FIG. 4 illustrates an exemplary diagram of an RFID tag reading system in accordance with a possible embodiment of the invention;

FIG. 5 illustrates an exemplary diagram of an RFID tag reading system using conductive surfaces in accordance with a possible embodiment of the invention;

FIG. 6 illustrates an exemplary diagram showing symbolic capacitance in an RFID tag reading system using conductive surfaces in accordance with a possible embodiment of the invention;

FIG. 7 illustrates an exemplary diagram of an RFID reading system for a pallet with containers having RFID tags and covered with conductive surfaces in accordance with a possible embodiment of the invention;

FIGS. 8A-8C illustrate exemplary diagrams of possible RFID tag reader configurations in accordance with possible embodiments of the invention;

FIG. 9 illustrates an exemplary diagram of an RFID tag reading system for stackable tote compartments in accordance with a possible embodiment of the invention;

FIG. 10 illustrates another exemplary diagram of an RFID tag reading system for stackable tote compartments in accordance with a possible embodiment of the invention;

FIG. 11 illustrates an exemplary diagram of an RFID tag reader in accordance with a possible embodiment of the invention; and

FIG. 12 illustrates an exemplary flowchart for a possible tag reading process in accordance with a possible embodiment of the invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The description herein uses several terms of art throughout and will be described in context below. “RFID device” may be a receiver, tag reader, transmitter, tag programmer, transceiver, etc. The term “associated” may be defined as being inside the container, attached to the container, sealing the container, etc. The “container volume” may include one container, or several containers. The “one or more RFID tags” may be associated with every container, some of the containers or just one of the containers in the container volume. An “RF signal” may be defined as any radio frequency signal or similar energy transmission that may be received and/or transmitted through any medium, including any wireless and/or wired medium. The term “obstructed” may be defined as not permitting or hindering RF signal communication. “RF signal communication” maybe defined as the transmission and/or reception of RF signals.

The present invention comprises a variety of embodiments, such as a system and method, and other embodiments that relate to the basic concepts of the invention. This invention may be particularly well suited to capacitively-coupled RFID systems which typically make use of near-field coupling mechanisms.

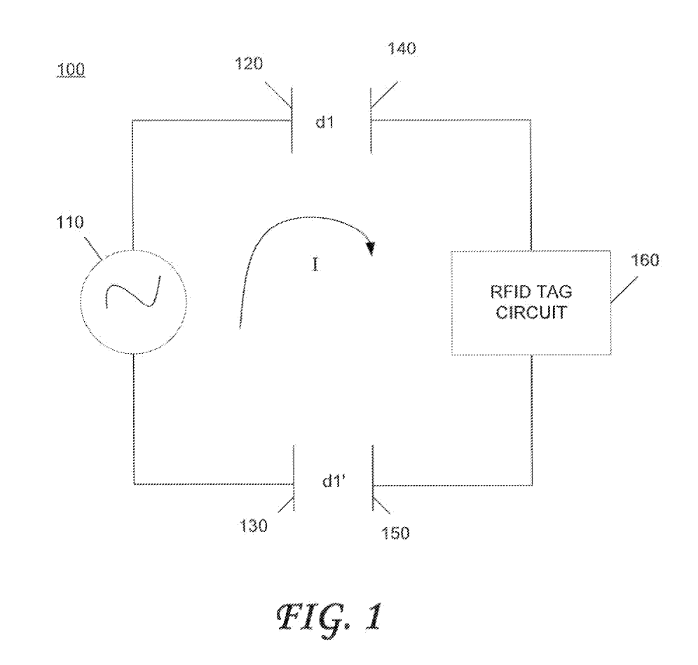

FIG. 1 illustrates an exemplary diagram of what is referred to as a dipole configuration of a capacitive RFID tag reading system 100 in accordance with a possible embodiment of the invention. In particular, the RFID tag reading system 100 may include RFID tag reader 110 and RFID tags circuit 160. The plates 120, 130, are associated with the RFID tag reader 110 and the plates 140, 150 are associated with the RFID tag circuit 160 and may be made of any conductive material known to one of skill in the art. The distance d1 between plate 120 and plate 140, and distance d1′ between plate 130 and plate 150 will differ as the distance between the RFID tag reader 110 and the RFID tag circuit 160 increases. When powered up, the RFID tag reader 110 capacitively couples through plates 120, 130 and plates 140, 150 to the RFID tag circuit 160. While an “RFID tag reader” is shown as element 110, the element 110 may represent an “RFID device” as described above which may be a receiver, tag reader, transmitter, tag programmer, transceiver, etc.

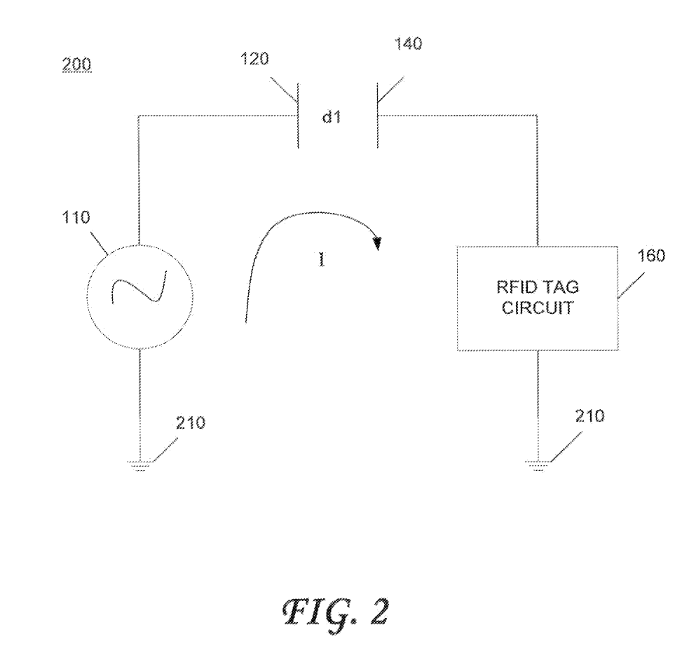

FIG. 2 illustrates an exemplary diagram of what is referred to as a monopole configuration of a capacitive RFID tag reading system 200 in accordance with a possible embodiment of the invention. In particular, the RFID tag reading system 200 may include RFID tag reader 110 and RFID tag circuit 160. In this example, only plates 120, 140 are needed as the RFID tag reader 110 and the RFID tag circuit 160 are coupled to ground 210.

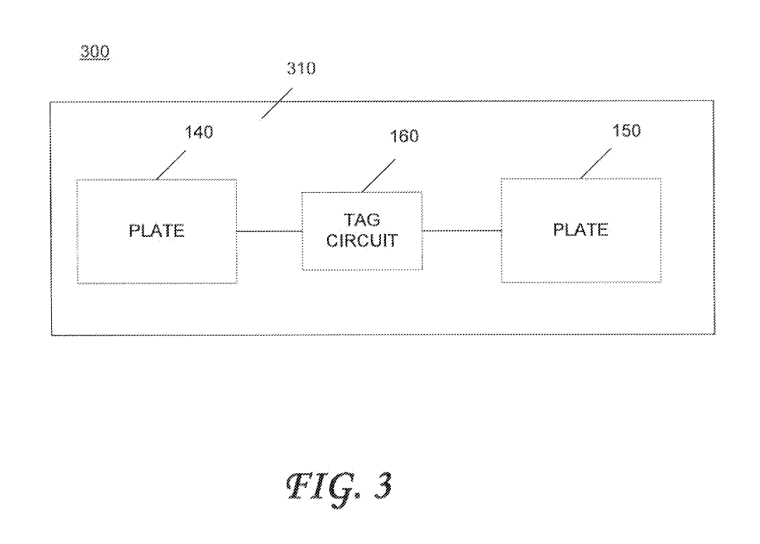

FIG. 3 illustrates an exemplary diagram of an RFID tag 300 in accordance with a possible embodiment of the invention. The RFID tag 300 may include RFID tag circuit 160 connected to plate 140 and plate 150 located on a surface 310. The surface 310 represents a substrate which may include a printed circuit board, paper, printed label, a container surface, or any other material known to one of skill in the art on which the above elements of the RFID tag 300 may be included. The RFID tag circuit 160 may include a memory which stores a variety of data or information, including the contents of the container to which it is associated, one or more identification numbers, etc. The RFID tag 300 may also be configured to transmit and/or receive information from another RF device.

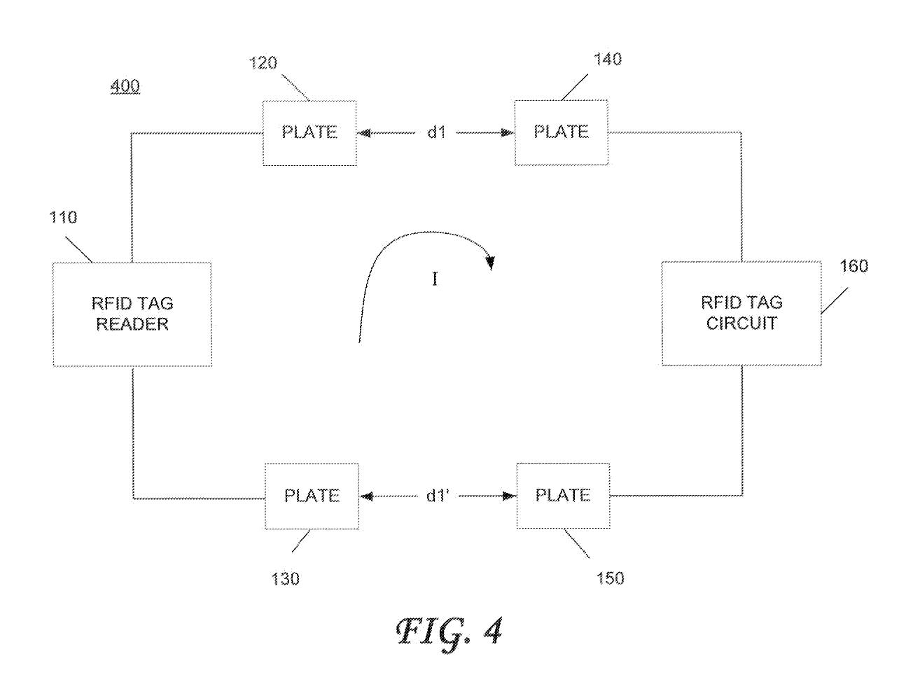

FIG. 4 illustrates an exemplary diagram of an RFID tag reading system 400 in accordance with a possible embodiment of the invention. The RFID tag reading system 400 may include RFID tag reader 110 and RFID tag circuit 160. In this example, plates 120, 140, 130, 150 are shown as in the RFID tag 300 example illustrated in FIG. 3. As stated above, plates 120, 140, 130, 150 may be made of any conductive material to create the capacitive coupling between the RFID tag reader 110 in the RFID tag circuit 160. However, as shown, as the distances d1 and d1′ increase, the required capacitance to couple the RFID tag reader 110 and RFID tag circuit 160 becomes increasingly difficult to maintain because the capacitive coupling impedance between the RFID tag reader 110 and the RFID tag circuit 160 is approximately inversely proportional to distances d1 and d1′.

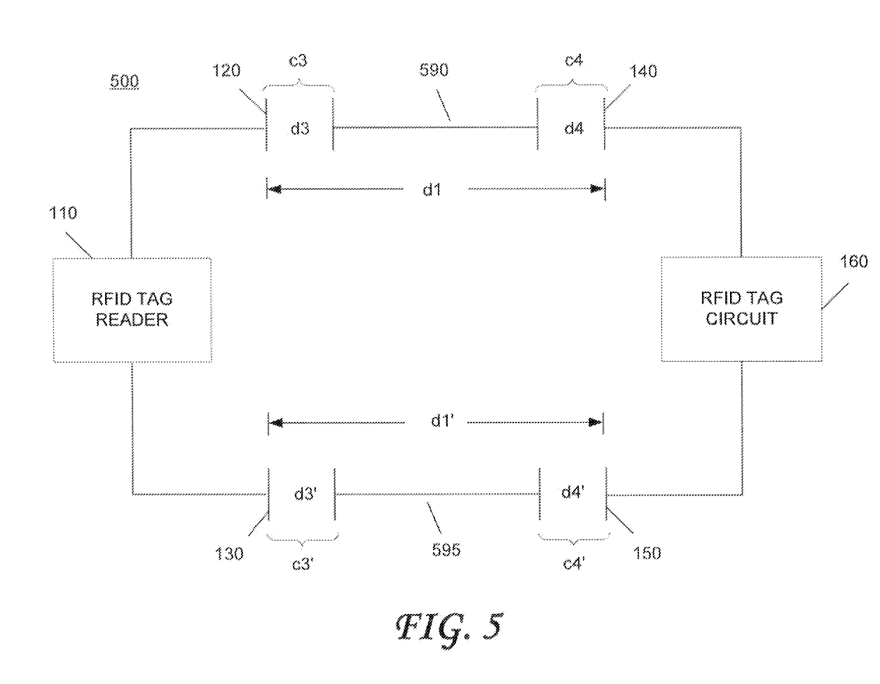

FIG. 5 illustrates an exemplary diagram of an RFID tag reading system 500 in accordance with a possible embodiment of the invention. The RFID tag reading system 500 may include RFID tag reader 110, RFID tag circuit 160 and conductive surfaces 590, 595. The distances between the plates 120, 130 connected to the RFID tag reader 110 and the conductive surfaces 590, 595 are represented by d3 and d3′. The distances between the plates 140, 150 connected to the RFID tag circuit 160 and the conductive surfaces 590, 595 are represented by d4 and d4′. The capacitances between the plates 120, 130 connected to the RFID tag reader 110 and the conductive surfaces 590, 595 are represented by c3 and c3′. The capacitances between the plates 140, 150 and the conductive surfaces 590, 595 are represented by c4 and c4′.

In this manner, the distances d1 and d1′ from FIGS. 1, 2 and 4 between 120, 130 and plates 140, 150, is now bridged by use of the conductive surfaces 590, 595. Therefore, the capacitances c3, c3′, c4, c4′ required to couple the RFID tag reader 110 to the RFID tag circuit 160 are larger and more easily maintained than the much smaller capacitances formed between plate pairs 120, 140 and 130, 150 in the absence of the conductive surfaces.

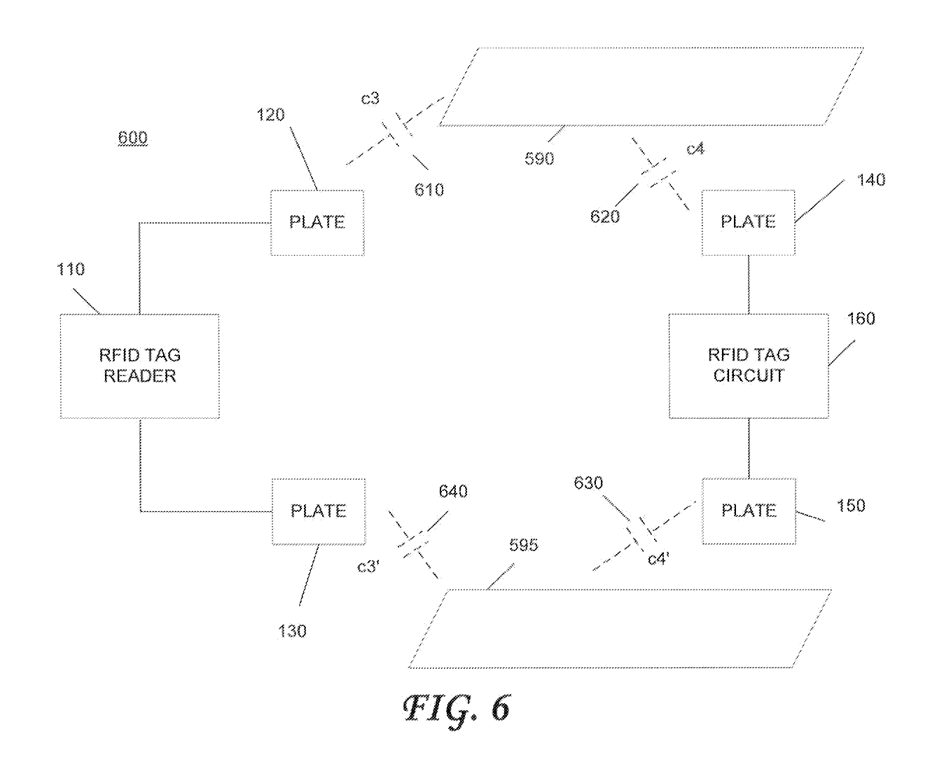

FIG. 6 illustrates the exemplary configuration in FIG. 5 using symbolic capacitor c3 between RFID tag reader 110 plate 120 and conductive surface 590, symbolic capacitor c4 between conductive surface 590 and RFID tag circuit 160 plate 140, symbolic capacitor c4′ between RFID tag circuit 160 plate 150 and conductive surface 595, and symbolic capacitor c3′ between conductive surface 595 and RFID tag reader 110 plate 130.

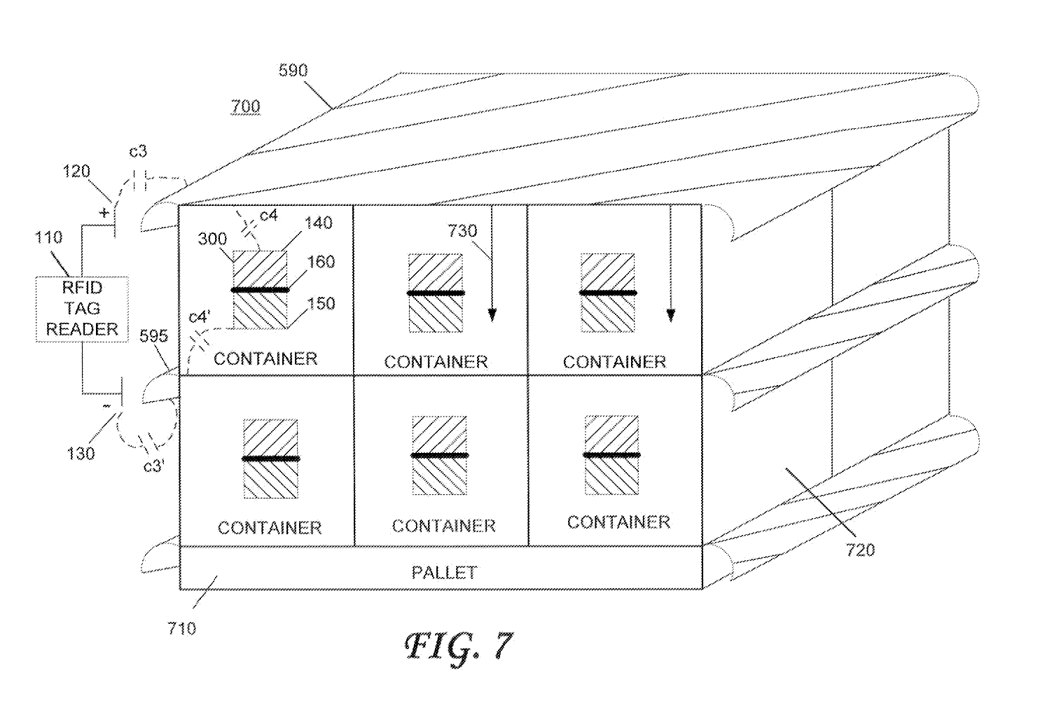

FIG. 7 is an exemplary diagram illustrating a possible pallet configuration 700 in accordance with an embodiment of the invention. Pallet configuration 700 includes one or more containers 720 sitting on top of pallet 710. One or more of the containers 720 in the pallet configuration 700 may include an RFID tag 300. As shown in FIG. 3, the RFID tag 300 includes RFID circuit 160 connected to plates 140, 150. A conductive surface 590 may be placed on the top of the containers 720 and another conductive surface 595 may be placed between container layers. Conductive surfaces may be formed using conductive sheeting inserted between the layers of containers. In capacitive RFID systems, high quality conductors are not required, so the conductive sheeting can be manufactured using low cost materials and processes, e.g., a paper substrate flood-coated with a carbon-based ink.

Depending on the numbers of columns and rows of containers 720, the number of conductive surfaces 590, 595 may vary in accordance with the invention. The pallet 710 may be such that one or more of the containers 720 may not have any RFID tags 300, while other containers 720 may have one or more RFID tags 300.

FIG. 7 shows the plates 120, 130 of an RFID tag reader 110 capacitively coupled to conductive surfaces 590, 595 which establishes an electric field 730 within the layer. To complete the circuit, as discussed in relation to FIGS. 1-6 above, conductive surface 590 is capacitively coupled to plate 140 which is connected to RFID tag circuit 160 of RFID tag 300 and conductive surface 590 is capacitively coupled to plate 120 of RFID tag reader 110, conductive surface 595 is capacitively coupled to plate 150 that is connected to RFID tag circuit 160 of RFID tag 300 and conductive surface 595 is capacitively coupled to plate 130 of RFID tag reader 110. In this manner, the RFID tag reader 110 can be capacitively coupled to each RFID tag 300 contained in the pallet configuration 700.

Therefore, if the plates of an RFID reader are coupled to the conductive surfaces 590, 595, the RFID tag 300 in the container located in the middle of the row of containers 700 may be read, transmitted to, communicated with, etc. As an alternative to using conductive sheeting as a way of introducing a conductive surface, conductive material can be incorporated in the surface of the containers such that a continuous conductive surface is formed when the containers are assembled on a pallet 710. In one possible embodiment, the conductive material may be deposited or printed on the surface of the containers using a low cost printing process. In addition, the products themselves may provide or aid in capacitive coupling if such products have electrically conductive properties, such as soda cans, for example.

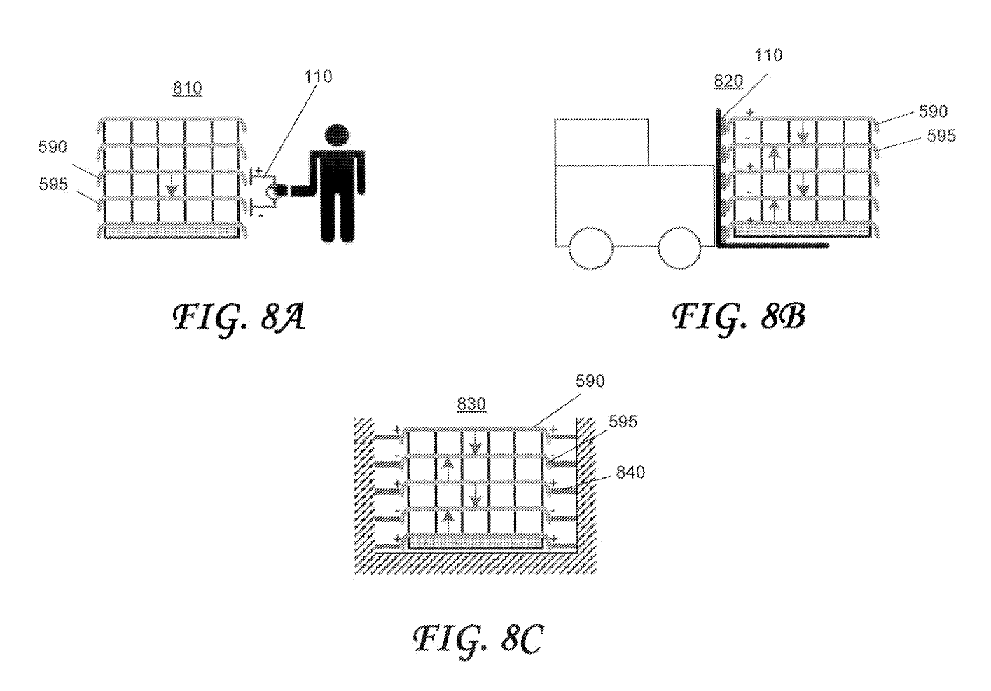

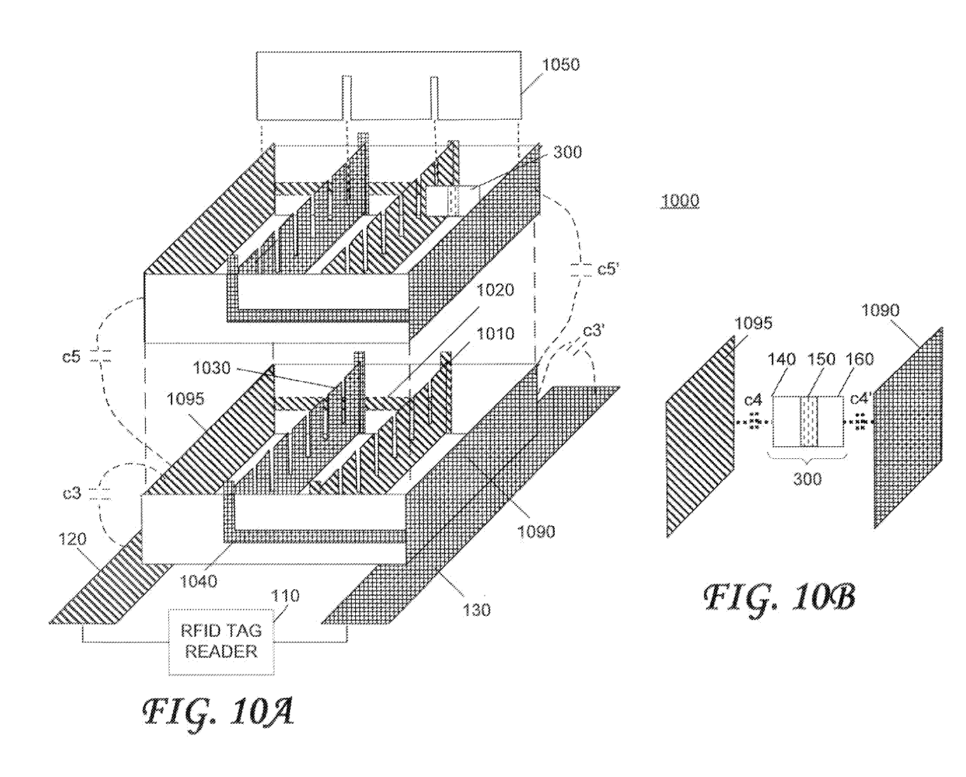

FIGS. 8A-8C illustrate examples of possible RFID tag reader 110 configurations in accordance with the embodiments of the invention. FIGS. 8A-8C are merely example given to show the wide variety of possible RFID tag readers 110 that will function in accordance with the invention. The RFID tag reader 110 could take many forms including, as shown in FIG. 8A in embodiment 810, a hand-held tag reader device 110 which is held by the individual that may be taking reading from one location or physically move the reader 110 across conductive surfaces 590, 595 from layer to layer of the pallet, for example. Embodiment 820 in FIG. 10B shows the RFID tag reader 110 integrated in the backstop of a forklift where appropriately positioned contacts couple to the individual electrodes or conductive surfaces 590, 595. Embodiment 830 in FIG. 10C shows the RFID tag reader 110 in a portal where reader “fingers” 840 brush against electrodes or conductive surfaces 590, 595 from the side, for example.

The excitation mode for the RFID tag reader 110 could be single-ended monopole (one surface grounded) or balanced dipole (the pair of surfaces driven 180 degrees out of phase), as is well-known to those skilled in the art. In the case of a handheld device, single-ended excitation may be preferable since the operator could provide body-coupled ground to both the reader (through its handle) and to the grounded surface with the user's hand, thus requiring only one electrode on the reader.

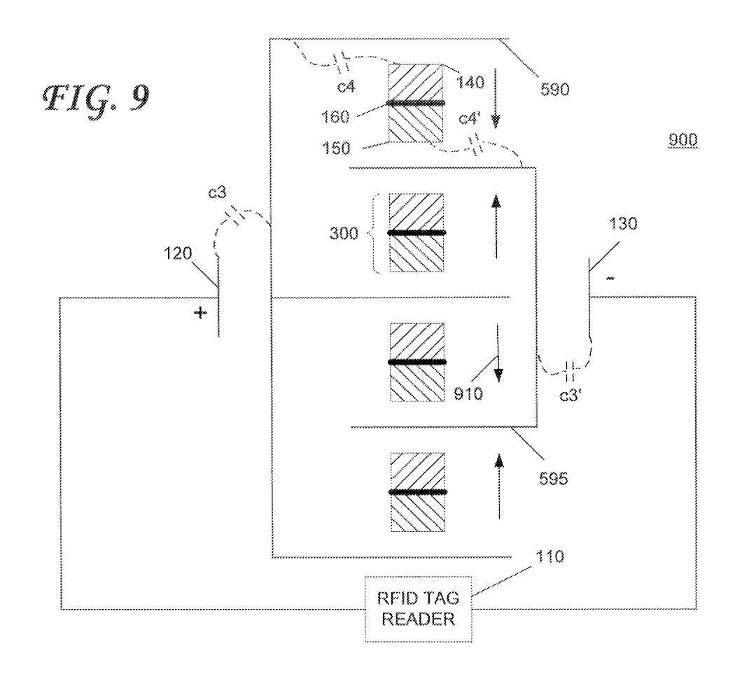

FIG. 9 shows an exemplary RFID tag reading system 900 embodiment that is applicable to compartmentalized structures such as a stackable tote system. RFID tags 300 and may be positioned in the compartmented structure such that one plate of the RFID tag 300 may be capacitively coupled to conductive surface 590 and the other plate may be capacitively passively coupled to conductive surface 595. The plates 120, 130 of RFID tag reader 110 are positioned to the capacitively coupled to conductive surfaces 590, 595, respectively. This completes the circuit and permits the RFID tag reader 110 to communicate with the RFID tags 300.

FIG. 10A shows an exemplary RFID tag reading system 1000 embodiment that is applicable to a stackable tote system with compartments containing RFID tagged items. These totes are often used in a manufacturing environment to carry products prior to final packaging. The tote structure may be constructed using electrically conductive dividers 1090, 1095 (basically serving the same purpose as conductive surfaces 590, 595 but also providing mechanical and structural properties) to establish an appropriately oriented electric field so that RFID tags situated within the compartments can be read. The system 1000 may also include plastic cross dividers 1050 to snap in between the compartments to prevent electrical shorts between conductive dividers 1090, 1095 and provide segregated compartments for tagged items.

FIG. 10B provides a magnified view of RFID tag 300 positioned between conductive surfaces 1090, 1095. In this manner, plate 140 capacitively couples (represented by c4) to conductive surface 1095 and plate 150 capacitively couples (represented by c4′) to conductive surface 1090.

Stacking provides the required capacitive coupling c5 and c5′ between tote structures. Capacitive coupling between layers of totes in the stack may also be aided by and/or provided using the products themselves if the product container has electrically conductive properties, such as a soda cans, for example. Thus, the capacitive coupling may be achieved by direct contact or indirect contact. In either case, the capacitive coupling provides electrical connection to each tote contained in the structure which enables communication between an RFID tag reader 110 and an RFID tag 300 in the tote structure.

At the base of the system 1000 are two electrically conductive strips 120, 130 serving as the plates connected to the RFID tag reader 110. When the RFID tag reader 110 is powered up, the capacitively coupled circuit should be complete (assuming totes with RFID tags are contained within).

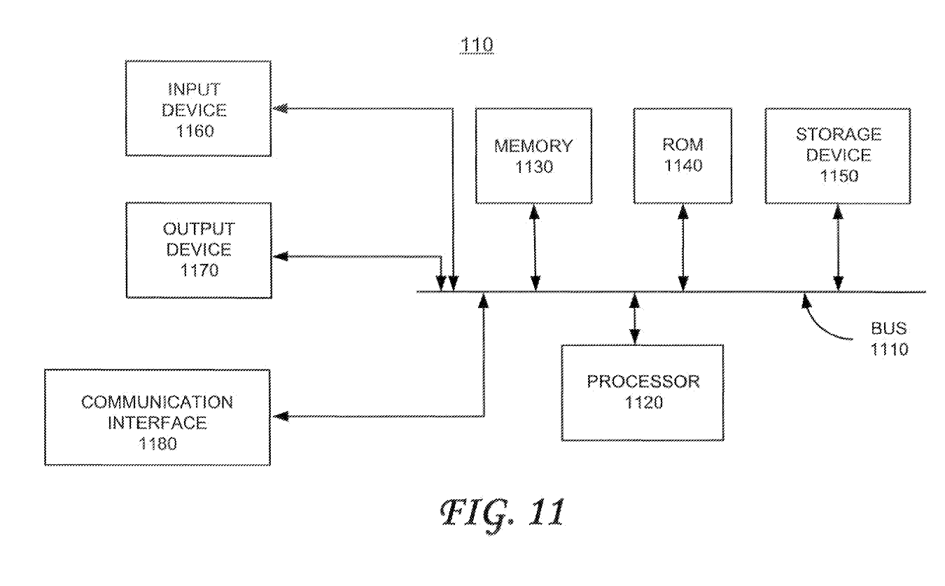

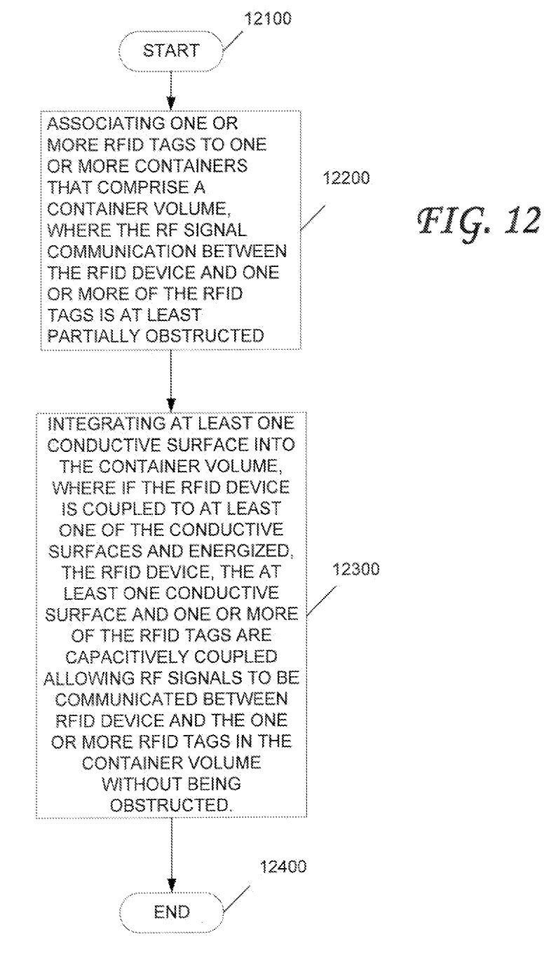

FIG. 11 illustrates an exemplary RFID tag reader 110, or device which may implement one or more modules or functions of the RFID tag reading process shown below in FIGS. 12. While an RFID tag reader 110 has been shown and discussed, one of skill in the art will recognize that any device capable of capacitively coupling to and communicating with RFID tags 300 is within the spirit and scope of the invention. For example, the RFID tag reader 110 may be an RFID transmitter, an RFID receiver, an RFID transceiver, or an RFID tag programmer. In this manner, the RFID reader 110 may also serve to transmit information to RFID tags 300 as well as reading or receiving data from them.

As shown in the figure, exemplary RFID tag reader 110 may include a bus 1110, a processor 1120, a memory 1130, a read only memory (RO 1140, a storage device 1150, an input device 1160, an output device 1170, and a communication interface 1180. Bus 1110 may permit communication among the components of the RFID tag reader 110 or RFID tag reading system 100. Certainly, one of skill in the art will recognize that the RFID reader 110 may include all of the elements, some of the elements or include other elements other than those shown in FIG. 11.

Processor 1120 may include at least one conventional processor or microprocessor that interprets and executes instructions. Memory 1130 may be a random access memory (RAM) or another type of dynamic storage device that stores information and instructions for execution by processor 1120. Memory 1130 may also store temporary variables or other intermediate information used during execution of instructions by processor 1120. ROM 1140 may include a conventional ROM device or another type of static storage device that stores static information and instructions for processor 1120. Storage device 1150 may include any type of media, such as, for example, magnetic or optical recording media and its corresponding drive.

Input device 1160 may include one or more conventional mechanisms that permit a user to input information to RFID tag reader 110, such as a keyboard, a mouse, a pen, a voice recognition device, etc. Output device 1170 may include one or more conventional mechanisms that output information to the user, including a display, a printer, one or more speakers, or a medium, such as a memory, or a magnetic or optical disk and a corresponding disk drive. Communication interface 1180 may include any transceiver-like mechanism that enables the RFID tag reader 110 to communicate via a network. For example, communication interface 1180 may include a modem, or an Ethernet interface for communicating via a local area network (LAN). Alternatively, communication interface 1180 may include other mechanisms for communicating with other devices and/or systems via wired, wireless or optical connections. In some implementations of the RFID tag reading systems disclosed herein, communication interface 1180 may not be included in the exemplary RFID tag reader 110 when the RFID tag reading process is implemented completely within a particular RFID tag reading system.

The RFID tag reader 110 may perform such functions in response to processor 1120 by executing sequences of instructions contained in a computer-readable medium, such as, for example, memory 1130, a magnetic disk, or an optical disk. Such instructions may be read into memory 1130 from another computer-readable medium, such as storage device 1150, or from a separate device via communication interface 1180.

The RFID tag reading systems discussed herein and the exemplary RFID tag reader 110 illustrated in figures and the related discussion are intended to provide a brief, general description of a suitable computing environment in which the invention may be implemented. Although not required, the invention will be described, at least in part, in the general context of computer-executable instructions, such as program modules, being executed by the RFID tag reader 110 processor 1120. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof through a communications network. In a distributed computing environment, program modules may be located in both local and remote memory storage devices.

For illustrative purposes, the RFID tag reading process will be described below in relation to the block diagrams shown in and discussed in relation to FIGS. 1-11, above.

FIG. 12 is an exemplary flowchart illustrating some of the basic steps associated with a possible method for facilitating RF communication between an RFID device and RFID tags in accordance with a possible embodiment of the invention. An RFID device may be any device that may send and/or receive RF energy, such as the RFID tag reader 110, for example. The process begins at step 12100 and continues to step 12200 where one or more RFID tags are associated to one or more containers that comprise a container volume where the RF signal communication between the RFID device and one or more of the RFID tags is at least partially obstructed.

At step 12300, at least one conductive surface may be integrated into the container volume. Therefore, if the RFID device is coupled to at least one of the conductive surfaces and energized, the RFID device, the at least one conductive surface and one or more of the RFID tags are capacitively coupled allowing RF signals to be communicated between RFID device and the one or more RFID tags in the container volume without being obstructed. The process goes to step 12400, and ends.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the RFID tag reading system embodiments described in FIGS. 1-11 each processing the content in various possible ways. It does not necessarily need to be one system used by all end users. Accordingly, the appended claims and their legal equivalents should only define the invention, rather than any specific examples given.

We claim:

1. A method for facilitating radio frequency (RF) communication between a radio frequency identification (RFID) device and RFID tags, comprising:
associating one or more RFID tags to one or more containers that comprise a container volume, wherein the RF signal communication between the RFID device and one or more of the RFID tags is at least partially obstructed; and
integrating at least one conductive surface into the container volume, wherein if the RFID device is coupled to at least one of the conductive surfaces and energized, the RFID device, the at least one conductive surface and one or more of the RFID tags are capacitively coupled allowing RF signals to be communicated between RFID device and the one or more RFID tags in the container volume without being obstructed.

2. The method of claim 1, further comprising:
at least one of receiving information from and transmitting information to one or more of the RFID tags.

3. The method of claim 1, wherein the containers contain one or more products, the products having at least some conductive properties and the products one of directly couple and capacitively couple to each other between layers in the container volume to allow RF signals to be communicated between RFID device and the one or more RFID tags in the container volume.

4. The method of claim 1, wherein at least one of the conductive surfaces is at least one of a sheet comprising conductive material and conductive material integrated into at least one container surface.

5. The method of claim 1, wherein one or more of the RFID tags are at least one of printed on material which can be attached to one or more of the containers and printed directly on one or more of the containers.

6. The method of claim 1, wherein one or more of the RFID tags comprise an RFID circuit and at least two conductors.

7. The method of claim 1, wherein the containers are placed in a partitioned stackable structure, the partitioned stackable structure providing capacitive coupling to allow the RFID device to communicate with one or more RFID tags.

8. The method of claim 1, wherein the RFID device is one of an RFID tag reader, an RFID transmitter, and an RFID transceiver.

9. The method of claim 1, wherein the RFID device is one of a handheld communication device, a communication device connected to a computing device, a communication device integrated into a vehicle, a communication device integrated into a forklift, a communication device integrated into a crane, a contact communication device, an RFID reader, a wireless communication device, and a portal communication device.

10. A system for facilitating radio frequency (RF) communication between a radio frequency identification (RFID) device and RFID tags, comprising:
one or more RFID tags associated with one or more containers that comprise a container volume, wherein the RF signal communication between the RFID device and one or more of the RFID tags is at least partially obstructed; and
at least one conductive surface integrated into the container volume, wherein if the RFID device is coupled to at least one of the conductive surfaces and energized, the RFID device, the at least one conductive surface and one or more of the RFID tags are capacitively coupled allowing RF signals to be communicated between RFID device and the one or more RFID tags in the container volume without being obstructed.

11. The system of claim 10, wherein the RFID device at least one of receives information from and transmits information to one or more of the RFID tags.

12. The system of claim 10, wherein the containers contain one or more products, the products having at least some conductive properties and the products one of directly couple and capacitively couple to each other between layers in the container volume to allow RF signals to be communicated between RFID device and the one or more RFID tags in the container volume.

13. The system of claim 10, wherein at least one of the conductive surfaces is at least one of a sheet comprising conductive material and conductive material integrated into at least one container surface.

14. The system of claim 10, wherein one or more of the RFID tags are at least one of printed on material which can be attached to one or more of the containers and printed directly on one or more of the containers.

15. The system of claim 10, wherein one or more of the RFID tags comprise an RFID circuit and at least two conductors.

16. The system of claim 10, wherein the containers are placed in a partitioned stackable structure, the partitioned stackable structure providing capacitive coupling to allow the RFID device to communicate with one or more RFID tags.

17. The system of claim 10, wherein the RFID device is one of an RFID tag reader, an RFID receiver, an RFID transmitter, and an RFID transceiver.

18. The system of claim 10, wherein the RFID device is one of a handheld communication device, a communication device connected to a computing device, a communication device integrated into a vehicle, a communication device integrated into a forklift, a communication device integrated into a crane, a contact communication device, an RFID reader, a wireless communication device, and a portal communication device.

19. A system for facilitating radio frequency (RF) communication between a radio frequency identification (RFID) device and RFID tags, comprising:
a plurality of containers arranged in multiple layers that comprise a container volume;
one or more RFID tags associated with one or more of the plurality of containers, wherein RF signal communication between the RFID device and one or more of the RFID tags is at least partially obstructed; and
at least one conductive surface integrated between layers in the container volume, wherein if the RFID device is coupled to at least one of the conductive surfaces and energized, the RFID device, the at least one conductive surface and one or more of the RFID tags are capacitively coupled allowing RF signals to be communicated between RFID device and the one or more RFID tags in the container volume without being obstructed.

20. The system of claim 10, wherein the RFID tags are at least one of printed on material which can be attached to one or more of the containers and printed directly on one or more of the containers.
